(19) United States
(12) Patent Application Publication
(10) Pub. No.: US 2023/0355462 A1
(43) Pub. Date: Nov. 9, 2023

(54) ANTI-FATIGUE SEATING SYSTEM

(71) Applicant: AEA Systems LLC, Dayton, OH (US)

(72) Inventors: Elias C. Ghanime, Sylvania, OH (US); Anthony P. Hall, Centerville, OH (US); Alan C. Prettyman, Dearborn, MI (US)

(21) Appl. No.: 18/311,296

(22) Filed: May 3, 2023

Related U.S. Application Data
(60) Provisional application No. 63/338,541, filed on May 5, 2022.

(51) Int. Cl. A61H 9/00; A47C 7/46; A47C 7/50

(52) U.S. Cl. CPC A61H 9/0078; A47C 7/467; A47C 7/506; A61H 2201/0149; A61H 2203/0431; A61H 2205/086; A61H 2205/108; A61H 2201/1633; A61H 2201/164; A61H 2205/106; A61H 2201/1645; A61H 2201/5002; A61H 2201/1238; A61H 2201/1623; A61H 2205/081; A61H 2201/5007; A61H 2201/5023

(57) ABSTRACT

A seating system includes a configurable electro-pneumatic mechanical device designed to be installed on any seat that is occupied for an extended period. The seating system incorporates a sequential stimulus process that is programmable and configurable to a user's needs. The seating system is adaptable and can be used in automotive, commercial vehicles, office chairs, lounging chairs, gaming chairs, hospitals, waiting rooms, theaters, schools, aviation and many military environments. In various embodiments, this invention is a completely new seating experience. The seating system, when added to any chair, combats static seating fatigue due to the absence of muscular contraction.

### BACKGROUND OF THE INVENTION

This invention claims the benefit of U.S. Provisional Application Ser. No. 63/338,541 filed May 5, 2022 and hereby incorporated by reference in its entirety.

This invention relates to seating systems, and more particularly, to a seating system to combat seating fatigue and provide a more comfortable seating experience.

According to the US Bureau of Labor Statistics, excessive seating for many occupations exceeding 80% of the workday is commonplace, and it is known that poor blood circulation is a major contributor to cardiovascular disease. Sitting for long periods has been identified as a major cause of concern among health officials.

The Mayo Clinic reports that research has linked sitting for long periods of time with a number of health concerns. (www.mayoclinic.org/healthy-lifestyle/adult-health/expert-answers/sitting/faq) These health concerns include obesity and a cluster of conditions—increased blood pressure, high blood sugar, excess body fat around the waist and abnormal cholesterol levels—that make up metabolic syndrome. Too much sitting overall and prolonged periods of sitting also seem to increase the risk of death from cardiovascular disease and cancer.

Any extended sitting, such as at a desk, behind a wheel or in front of a screen, can be harmful. An analysis of studies of sitting time and activity levels found that those who sat for more than eight hours a day with no physical activity had a risk of dying similar to the risks of dying posed by obesity and smoking. However, research has shown that moderately intense physical activity or stimulation countered the effects of too much sitting. Another study found that sitting time contributed little to mortality for people who were most active.

Typical desk chairs are often designed for comfort, adjustability and durability. However, common seating arrangements offer little to stimulate the occupant and avoid the above described health concerns.

These and other shortcomings in the prior art have been addressed by various embodiments of this invention as described below.

### SUMMARY OF THE INVENTION

According to various embodiments, this invention is a seating system including a configurable electro-pneumatic mechanical device designed to be installed on any seat that is occupied for an extended period. This invention has several design iterations and can be adapted to fit any work or social environment.

The seating system according to various embodiments of this invention incorporates a sequential stimulus process that is programmable and configurable to a user's needs. The system is adaptable and can be used in automotive, commercial vehicles, office chairs, lounging chairs, gaming chairs, hospitals, waiting rooms, theaters, schools, aviation and many military environments. In various embodiments, this invention is a completely new seating experience offering a paradigm shift for the seating industry.

This invention, when added to any chair, provides a new approach to combat static seating fatigue due to the absence of muscular contraction. It is designed to help the occupant stay alert and be more productive. This invention combats seating fatigue in a novel way, by stimulating the occupants' lower legs and buttocks. The occupant may be less likely to leave the chair when not distracted by discomfort.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is diagram of a seated user showing schematically various muscles and blood flow paths which are targeted for stimulation with various embodiments of this invention;

FIG. 2 is a schematic diagram of a seated occupant with stimulation provided by various embodiments of this invention;

FIG. 3 is a schematic diagram of lower lumbar stimulation provided to a seated occupant by various embodiments of this invention;

FIG. 4 is a schematic diagram of upper torso stimulation provided to a seated occupant by various embodiments of this invention;

FIG. 5 is a perspective view of one embodiment of a seating system according to this invention; and

FIG. 6 is a schematic diagram of a control system for use in one embodiment of a seating system according to this invention.

### DETAILED DESCRIPTION OF THE INVENTION

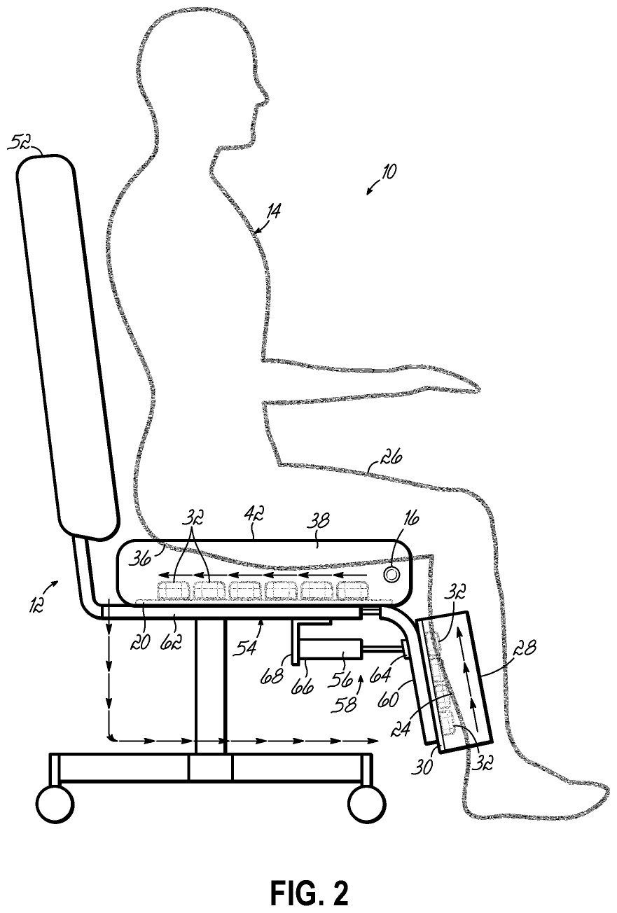

According to various embodiments of this invention, a seating system 10 adapted for use on a wide variety of chairs and seats 12 is provided as shown in FIGS. 2-6. When in the normal seated position, a user 14 can initiate the system 10 via a hand control start button 16, a lever located beside the seat 12 or alternatively, the seating system 10 may be initiated by using a Bluetooth activated hand device 18 via personal mobile device using an appropriate app. The seating system 10 may be incorporated into a chair or seat 12 or may be added to an existing seat 12. The seating system 10 may be divided into sections located in proximation to various parts of the user's body. The human body is considered to have three main axes including a frontal axis which runs from left to right through the center of the body, a sagittal (also known as the antero-posterior) axis which runs from front to back through the center of the body, and a vertical axis which runs from top to bottom through the center of the body. In various embodiments, this invention enhances the blood flow in the vertical axis direction of the user 14.

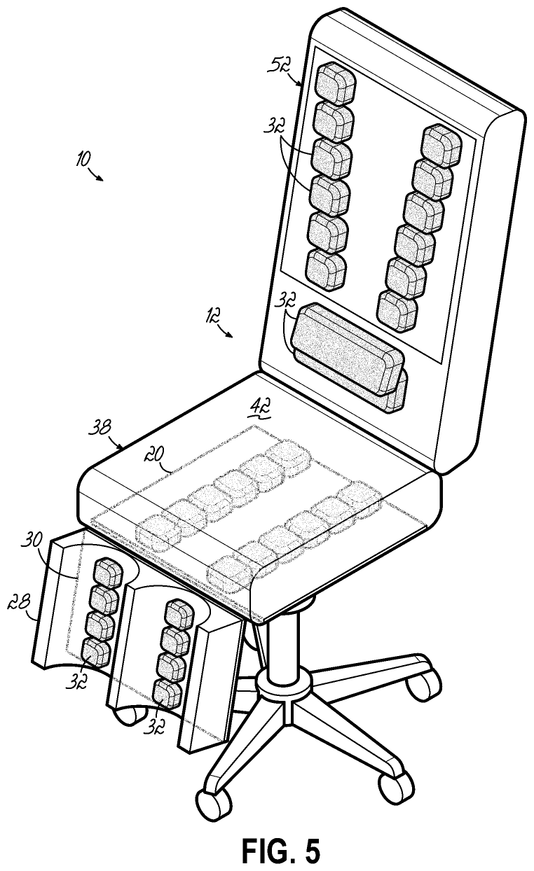

For example, in the embodiment shown in FIG. 5, the seating system 10 may have a calf section 10a positioned adjacent to the user's calves 24, a thigh section 10b positioned adjacent to the user's thighs 26, a lower lumbar section 10c positioned adjacent to the user's lower lumbar and buttocks region 36 and a back section 10d positioned adjacent to the user's upper back 52. Each section 10a, 10b, 10c and 10d may be oriented generally along the user's vertical axis and may be continuous with other sections 10a, 10b, 10c and 10d of the system 10 in some embodiments, discreet in other embodiments of this invention or combinations of these arrangements. Each section may have a substrate 30.

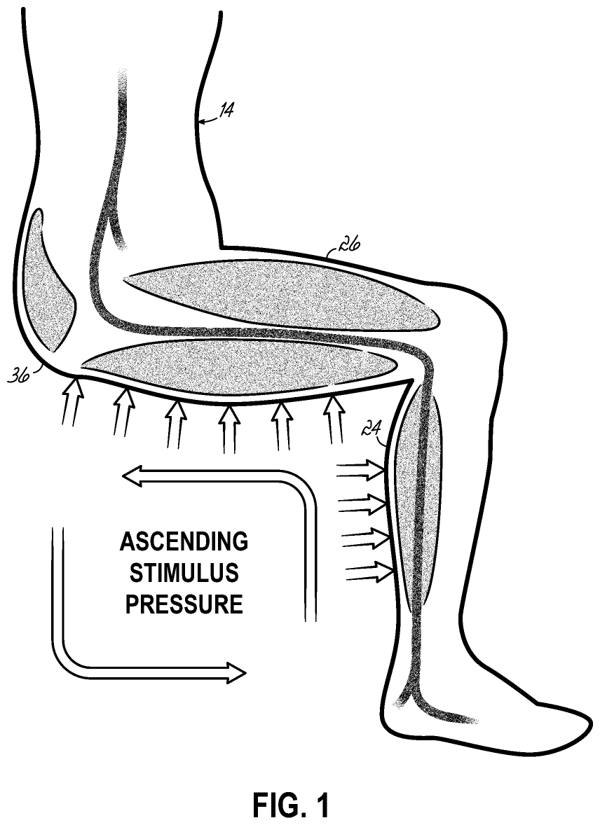

Once activated the system 10 provides stimulation to the user 14 which will travel generally along the vertical axis through and between selected sections 10a, 10b, 10c and 10d, combinations thereof or all of the sections 10a, 10b, 10c and 10d (see FIG. 1). In other embodiments of this invention, the stimulation is not limited to the vertical axis. Referring to FIG. 2, the stimulation may originate from under a seat bottom 20 and contact the back of the occupants' legs in sections 10b and 10c adjacent the user's calf 24 and thigh 26. The substrate 30 of the calf section 10a is a distinct leg form 28 of the seating system 10 with a pair of generally vertically oriented parallel arcuate open channels 29, one for each calf 24, that will guide the calves 24 of the user 14 into position. The seating system 10 may include one or more inflatable bladders 32 to produce the stimulation. Once activated, eight unique inflatable air bladders 32a (four per leg) vertically mounted on the substrate 30, will extend outwardly and cradle both of the calves 24 of the occupant 14 in section 10a.

As seen in FIG. 5, four pairs of stacked bladders 32 located in the seating system substrate 30 in section 10a will begin to apply pressure in an ascending order to the back of the occupants' calves 24 creating a massaging effect. This effect travels up the back of the calves 24 and transitions immediately into a seat cushion 38 in section 10b, working along the length of the occupant's thighs 26 to the buttocks 36. When the last bladder 32 in the sequence effect has passed the rear of the buttocks 36, the system 10 will repeat the cycle in one embodiment. This motion can be programmed to repeat multiple times if required. When the cycles in sections 10a and 10b are complete, the activation provided by the seating system 10 will stop, the leg form 28 will retract and return to the home position, located under the seat cushion 38. The ascending pressure created by the bladders 32 is intended to rejuvenate the user's muscles weakened from prolonged sitting. Blood and lymph fluid stored in the systemic capillaries is pressured to flow into the venules and veins and back into the circulatory system.

An occupant detection switch 40 may be located in the seat cushion 38. If the occupant 14 leaves the seat 42, the system 10 will stop, turn a pump 44 off and reset itself. Simultaneously, a signal is sent to the hand control unit 18 which in turn communicates via LIN BUS to a system electronic control unit (ECU) 46. The ability of the seating system 10 to detect an occupant 14 leaving the seat 12 prevents unnecessary system cycling when the seat 12 is not occupied.

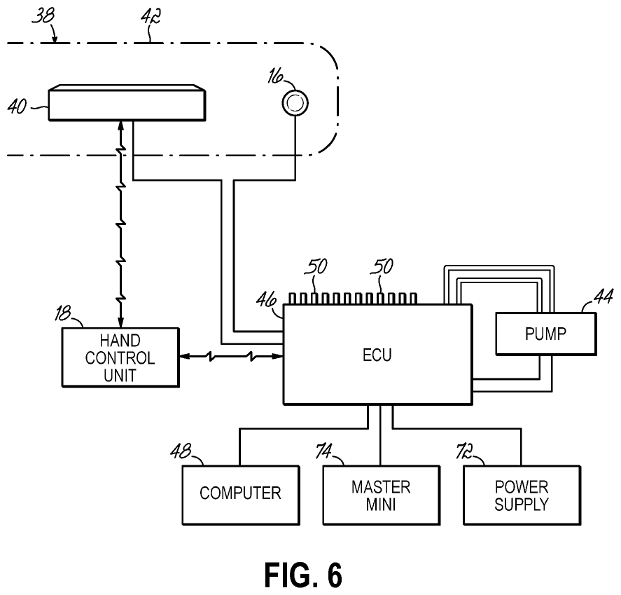

Referring to FIG. 6, the ECU 46 is programmed to count the number of completed cycles, and how many motor revolutions have occurred. The program may be written specifically for this application. The ECU 46 can communicate with a computer 48 via USB and display the stored data for continuing analysis. Cycle data will not be stored if the cycle is interrupted.

The ECU 46 contains several directional control valves (DCV) 50 which are programmed to control the amount of air flow each bladder 32 requires. In one embodiment of this invention, each valve 50 produces about 5 LPM, it takes 7 secs. to inflate a pair of test bladders each 115 mm×75 mm to a pressure of 50 kPa. The calculated balance between pressure and time variables create the stimulus effect.

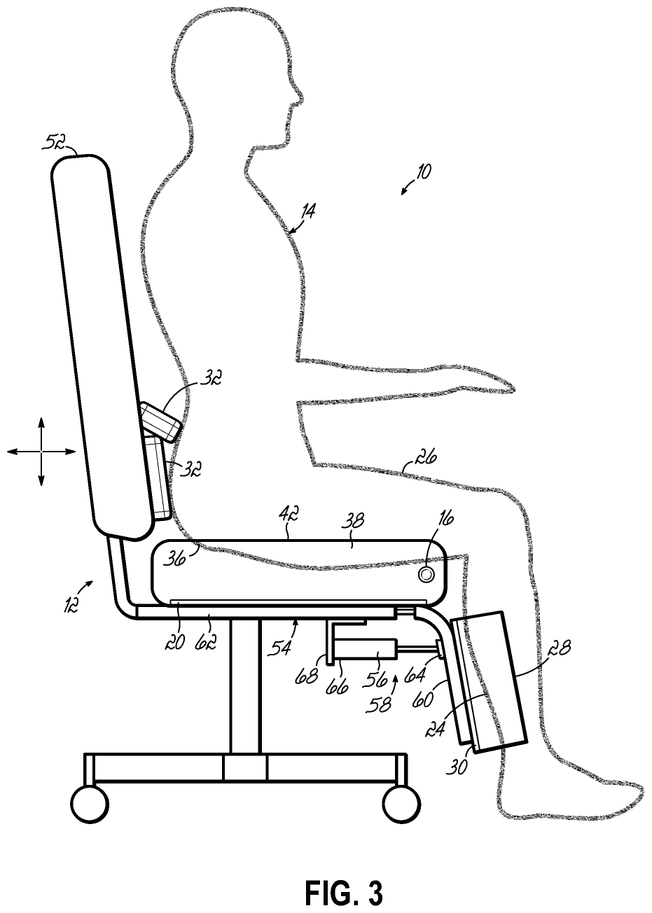

As shown in FIGS. 3 and 5, a pair of strategically positioned inflatable bladders 32 may be provided in a seat back section 10c to provide adjustable lumbar support. From the hand control unit 18, the occupant 14 can select the lumbar support prominence and position they find comfortable. The two inflatable bladders 32 are positioned as such when inflated will provide an increased range of lower back and pelvic support based on occupant preference.

This invention in various embodiments offers optional chair back stimulus extending just above the lumbar support in section 10c, continuing up the length of the seat back to back section 10d. The associated bladders 32 in section 10d are positioned specifically to target the user's vertical erector spinae muscle group. The back stimulus is provided in section 10d with the same unique sequencing and will provide tension relief to the occupant 14 when required.

The working bladders 32 in the seat cushion 38 and leg structure 28 may be made from polyurethane film which are geometrically cut and radio frequency (RF) welded or laser welded to create individual bladders 32.

Twelve bladders 32 in section 10b may be strategically located in pairs in the seat cushion 38 to cradle the buttocks 36. Eight smaller bladders 32 arranged in pairs in section 10a are specifically attached to the leg mechanism substrate 30. Combined are four (4) rectangular chambers 32 in pairs, mounted vertically on opposite sides of the smaller leg chambers 32. The support structure 30 may be covered in a flexible color coordinated foam laminate. This complete assembly may be mounted to a retraction mechanism frame 54 which is mounted under the seat bottom 20.

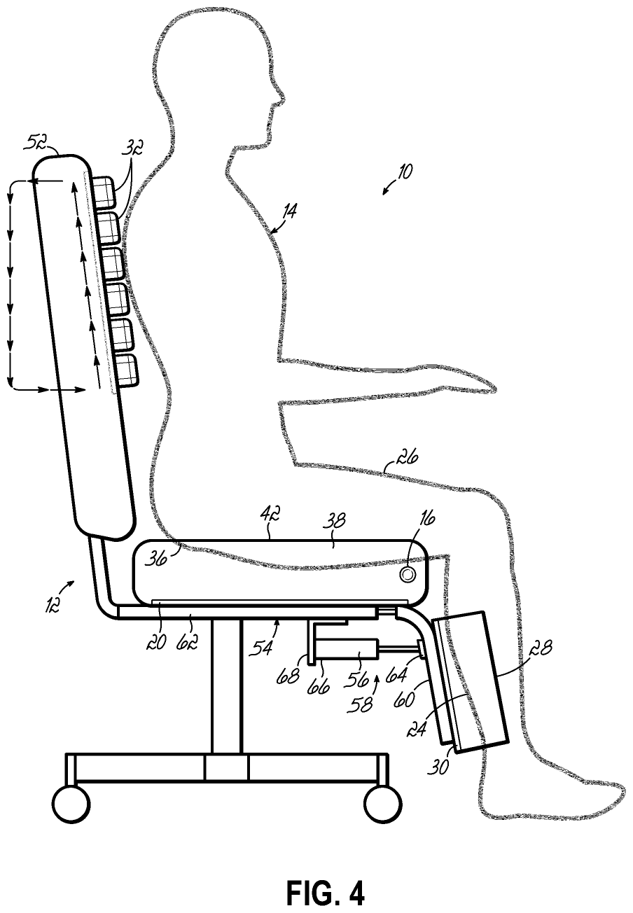

As shown in FIGS. 4 and 6, when the occupant 14 presses the start button 16, a signal is sent to the ECU 46 to start the event. The leg form 28 may be projected forwardly to receive the user's calves 24 by a linear actuator 56 which will slowly drives a retraction assembly 58 forward. In one embodiment, the linear actuator 56 travel length is eight inches. A frame assembly 60 travels on linear guides 62 which are either ball bearing and or low friction plastic. A rod main shaft 64 is attached to the frame 60, the end cap 66 of the actuator 56 is mounted to a bracket 68 at the seat bottom 20. The lever mechanism for the fore-aft travel may be manually activated. Alternatively, the carriage system extends in response to a command from a mobile APP software, or, alternatively via a manual lever mechanism located under the seat structure.

A leg retraction assembly 58 will travel forward until the occupant 14 is satisfied of the leg placement and can then release the button. The forward motion location is achieved via a 3/3 DCV within the ECU 46. Once the leg retraction location is determined, two vertical mounted chambers 32 in section boa inflate and cradle each of the occupant's calves 24. To achieve this, an additional 3/3 DCV in the ECU 46 is used. These bladders 32 will remain inflated for the duration of the stimulus cycle.

An ascending pressure wave for section 10a will result as each of the chambers 32 inflation cycle travel up the back of the occupants' calves 24, transitioning immediately into section 10b for the thighs 26 and seat cushion 38 as shown in FIG. 1. When the last chamber 32 in the seat cushion 38 begins to deflate, the stimulus sequence will repeat; six complete cycles may be programmed.

The number of repetitions is programmable, but it has been determined that six cycles repeated four times per hour satisfied proof of concept testing. The system 10 is designed to provide a complete cycle within 60-100 seconds. This value is programmable.

Air pressure may be provided by a 12 Vdc pump 44. The pump 44 air pressure travels through the ECU pathway architecture, providing about 5 LPM at each of the ports. The ECU 46, pump 44, power supply 72 and master mini 74 are located underneath the lower leg form 28. The system power is provided by 120 vac plug cord. The power supply is fed 120 vac and is converted to 12 vdc directly to the ECU 46. A rechargeable 12 Vdc battery may also provide a power source.

The hand control unit 16 receives about 3 vdc from the ECU 46 and provides control of the system functions. Alternatively, the system 10 can be controlled via Bluetooth from a hand-held device 18 directly via the LIN BUS Master Mini 74 interface.

The plurality of pneumatic bladders 32 may be located beneath mesh or another material layer as shown in section 10b of FIG. 5. The plurality of pneumatic bladders 32 are configured to inflate in response to pneumatic pump 44. Illustratively, bladders 32 are spaced apart from each other and arranged to provide the desired effect.

Control system may further include a digital signal processor, GPS-Fit, Bluetooth to a mobile device, and a wired or wireless connection for diagnostics. Control system may also include a thermal control system configured to communicate with a heat source as well as controlling pumps, massage, bolsters, GPS-Fit and valve blocks.

Control system may be configured to connect to one or more smart devices and communicate with occupant 14 via the smart device such as via a display screen. As such, the seating system 10 may interact with occupant 14 and provide the determined data and recommendations to occupant 14 through a plurality of the occupant's smart devices. The seating system 10 may receive occupant input via smart devices. In other embodiments, control system includes a display and/or audio output.

Pneumatic functionality may also be included for controlling pumps, massage, bolsters, GPS-Fit, and valve blocks. Air flow may be provided with respect to the location of the occupant 14. The airflow is illustrated with arrows and shows the flow moving upward from the calf section 10a to the thigh section 10b and may include the lumbar section 10c and the back section 10d in some embodiments. Control system may be configured to activate functional pneumatics of some or all of the sections 10a, 10b, 10c, and 10d.

From the above disclosure of the general principles of this invention and the preceding detailed description of at least one embodiment, those skilled in the art will readily comprehend the various modifications to which this invention is susceptible. Therefore, we desire to be limited only by the scope of the following claims and equivalents thereof.

1. A seating system comprising:
a seat bottom adapted to support a user's thighs and buttocks;
a seat back adapted to be juxtaposed to the user's back;
a leg form adapted to be juxtaposed to the user's calves;
a plurality of bladders located within at least one of the seat bottom, the seat back and the leg form and sequentially arranged from a low end to a high end aligned with a vertical axis of the user;
a pump operatively coupled to the plurality of bladders to selectively inflate and deflate the plurality of bladders;
a control unit operatively coupled to the pump to control the selective inflation and deflation of the plurality of bladders;
wherein the seating system provides stimulation to the user generally aligned with the vertical axis of the user by sequential inflation of at least some of the plurality of bladders.

2. The seating system of claim 1 wherein the control unit selectively inflates the plurality of bladders in an ascending direction aligned with the vertical axis.

3. The seating system of claim 2 wherein the plurality of bladders are located in the leg form and seat bottom.

4. The seating system of claim 1 wherein the leg form further comprises:
a pair of arcuate open channels, each of which is adapted to receive therein one of the calves of the user.

5. The seating system of claim 4 wherein a first set of the plurality of bladders is arranged generally vertically in one of the channels of the leg form and a second set of the plurality of bladders is arranged generally vertically in the other one of the channels of the leg form.

6. The seating system of claim 1 further comprising:
an assembly coupled to the leg form to extend the leg form for receipt of the user's calves and retract the leg form for stowage.

7. The seating system of claim 1 wherein a first set of the plurality of bladders is in the seat bottom and arranged in alignment with the vertical axis of the user.

8. The seating system of claim 7 further comprising:
a second set of the plurality of bladders in the seat bottom and arranged generally parallel to the first set, the first and second sets of the plurality of bladders each underlying one of the user's highs when seated on the seating system.

9. The seating system of claim 1 wherein a first set of the plurality of bladders is in the seat back and arranged generally vertically.

10. The seating system of claim 9 further comprising:
a second set of the plurality of bladders in the seat back and arranged generally vertically, the first and second sets of the plurality of bladders being spaced from each other.

11. The seating system of claim 1 wherein a first set of the plurality of bladders is located on the seat back and juxtaposed to a lumbar region of the user when seated on the seating system.

12. The seating system of claim 11 wherein the first set further comprises a first and a second lumbar bladder each oriented generally horizontally in at least a partially

13. A seating system comprising:
a seat bottom adapted to support a user's thighs and buttocks;
a seat back adapted to be juxtaposed to the user's back;
a leg form adapted to be juxtaposed to the user's calves, wherein the leg form further comprises a pair of arcuate open channels, each of which is adapted to receive therein one of the calves of the user;
an assembly coupled to the leg form to extend the leg form for receipt of the user's calves and retract the leg form for stowage;
a plurality of bladders located within at least one of the seat bottom, the seat back and the leg form and sequentially arranged from a low end to a high end aligned with a vertical axis of the user;
a pump operatively coupled to the plurality of bladders to selectively inflate and deflate the plurality of bladders;
a control unit operatively coupled to the pump to control the selective inflation and deflation of the plurality of bladders;
wherein the seating system provides stimulation to the user generally aligned with the vertical axis of the user by sequential inflation of at least some of the plurality of bladders;
wherein the control unit selectively inflates the plurality of bladders in an ascending direction aligned with the vertical axis;
a first set of the plurality of bladders arranged generally vertically in one of the channels of the leg form and a second set of the plurality of bladders arranged generally vertically in the other one of the channels of the leg form;
a third and a fourth set of the plurality of bladders in the seat bottom and arranged generally parallel to each other, the third and fourth sets of the plurality of bladders each underlying one of the user's highs when seated on the seating system;
a fifth and a sixth set of the plurality of bladders in the seat back and arranged generally vertically, the fifth and sixth sets of the plurality of bladders being spaced from each other; and
a seventh set of the plurality of bladders located on the seat back and juxtaposed to a lumbar region of the user when seated on the seating system.

14. The seating system of claim 13 wherein the seventh set further comprises a first and a second lumbar bladder each oriented generally horizontally in at least a partially

15. A method of stimulating blood flow in a user seated on a seat, the method comprising the steps of:
positioning calves of the user relative to a leg form of the seat;
positioning thighs and buttocks of the user relative to a seat bottom of the seat;
positioning a back of the user relative to a seat back of the seat;
sequentially inflating at least some of a plurality of bladders embedded in at least one of the leg form, the seat bottom and the seat back of the seat to thereby stimulate the user.

16. The method of claim 15 further comprising:
aligning the plurality of bladders along a vertical axis of the user.

17. The method of claim 15 further comprising:
selectively extending the leg form to engage the calves of the user; and
selectively retracting the leg form to a stowed position.

18. The method of claim 16 wherein the sequentially inflating step is in an upward direction generally along the vertical axis of the user.

19. The method of claim 15 wherein the sequentially inflating step is performed in the leg form and the seat bottom.

20. The method of claim 15 wherein the plurality of bladders include a set of bladders juxtaposed to a lumbar region of the user.

21. The method of claim 15 wherein the position of the calves of the user step further comprises:
cradling each calf of the user in one of two arcuate open channels on the leg form.
